(19) United States
(12) Patent Application Publication
(10) Pub. No.: US 2005/0174498 A1
(43) Pub. Date: Aug. 11, 2005

(54) In-vehicle video/audio display device

(76) Inventor: Tai-Hsiung Wu, Taoyuan (TW)

Correspondence Address: DELLETT AND WALTERS, P. O. BOX 2786, PORTLAND, OR, 97208-2786, US

(21) Appl. No.: 10/775,690

(22) Filed: Feb. 10, 2004

(51) Int. Cl. H04N 5/64

(52) U.S. Cl. 348/837; 725/77

(57) ABSTRACT

A video/audio display device is installed in a headrest of a seat in a vehicle and allowed to be directed and operated by backseat passengers. The video/audio display device includes an engagement base defined with a shallow cavity, a disc player retained in the cavity, a display panel for image display connected to the disc player through an angle adjusting plate. The angle adjusting plate has opposite edges along which a first pivoting mechanism and a second pivoting mechanism are formed. The two pivoting mechanisms, for respectively connecting to the display panel and the disc player, allow the display panel to be fixed at any desired angle based on the user's requirement.

### BACKGROUND OF THE INVENTION

1. Field of the Invention

The present invention relates to a video/audio display device, and more particularly to a video/audio display used in a vehicle, which is suitable to be directly operated by backseat passengers.

2. Description of Related Art

For usual passenger cars, an entertainment system is a very common accessory installed in the vehicle. Typically, a video display device including a disc play host and a monitor is integrated into the car. The monitor is often attached at the back of headrest of the driver's or front passenger's seat thus allowing the backseat passengers to watch. In another aspect, the proper position for installing the disc play host may be the trunk or under the passenger seat. An operation panel of the said disk play host is usually mounted on the dashboard.

However, such an arrangement of the monitor and the disc display host is quite inconvenient for driver and each passenger.
1. The backseat passengers, who actually view the video programs on the monitor, are unable to directly to control the disc play host. Instead, passengers must ask the driver or the front passenger to operate the host, which may possibly interfere with the driver's concentration while driving.
2. When replacing the discs, the replacement operation can not be accomplished inside the car when said disc play host is installed in the trunk, i.e. the passengers must leave the car.
3. Although the monitor is the LCD display having a flat slimline structure, a lot of space is still occupied. Further, such an LCD monitor is not adjustable in its viewing angle based on the user's demand.

Therefore, it is desired to provide a novel video/audio display device to obviate the aforementioned drawbacks.

### SUMMARY OF THE INVENTION

The main objective of the present invention is to provide a video/audio display device for use in a vehicle, wherein the video play host and image display monitor are all integrated in the device of the present invention.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a video/audio display device in accordance with the present invention;

FIG. 2 is a perspective view of the video/audio display device of FIG. 1 in assembly;

FIG. 3 is a cross sectional view showing the video/audio display device of FIG. 1 is embedded in a headrest of a seat;

FIG. 4 is a cross sectional view showing the video/audio display device of FIG. 1 is folded; and

FIGS. 5 and 6 are operational views illustrating the angle adjustment of a monitor of the present invention.

### DETAILED DESCRIPTION OF THE PREFERRED EMBODIMENT

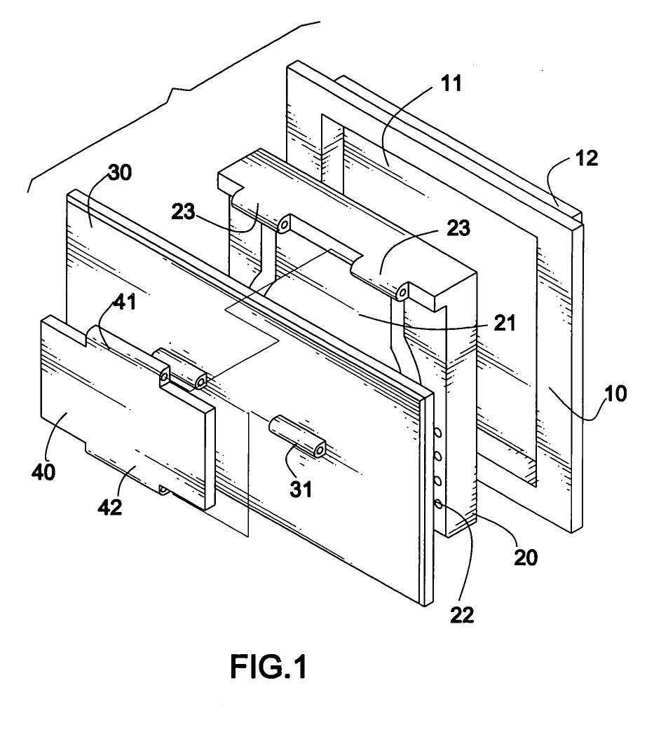

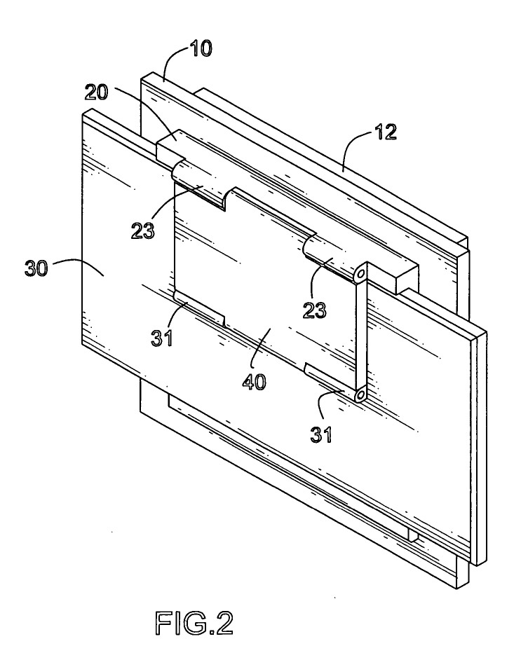

With reference to FIGS. 1 and 2, the video/audio display device in accordance with the present invention comprises an engagement base (10), a disc player (20), a display panel (30) and an angle adjusting plate (40) linking the disc player (20) and the display panel (30).

The engagement base (10) is formed by a rectangular body in which a shallow cavity (11) is defined, whereby the shape of the engagement base (10) is formed substantially to be a dish.

The disc player (20) is securely retained in the cavity (11) of the engagement base (10). The disc player (20) preferably supports diverse disc formats, such as the DVD disk and VCD disk. The disc player (20) has a disc retaining chamber (21) in which the disc intended to be played is placed. A plurality of operation buttons (22) to be pressed by users is provided around the disc retaining chamber (21). A first pivoting mechanism (23) is formed at one top edge of the disc player (20).

The display panel (30), preferably an LCD display monitor, has an inner surface for image display and an outside surface on which a second pivoting mechanism (31) is formed. Sound output elements, such as mini speakers, could be integrated to the flat panel or alternatively to the disc player (20).

The angle adjusting plate (40) is consisted of a rectangular plate having two opposite edges (not numbered) along which a first and a second pivoting block (41)(42) are formed. The two pivoting blocks (41)(42) are respectively connected to the first pivoting mechanism (23) and the second pivoting mechanism (31), whereby the display panel (30) is pivotally attached to the disc player (20). It is should be noted that the connection of the two pivoting mechanisms (23)(31) between the two pivoting blocks (41)(42) is the same as the well-known pivoting mechanism applied in a notebook computer, between the LCD display and the host. Therefore, such a connection not only supplies the relatively pivoting connection between the display panel (30) and the disc player (20), but also allows the display panel (30) to be maintained at any desired angle when the angle adjusting operation has finished.

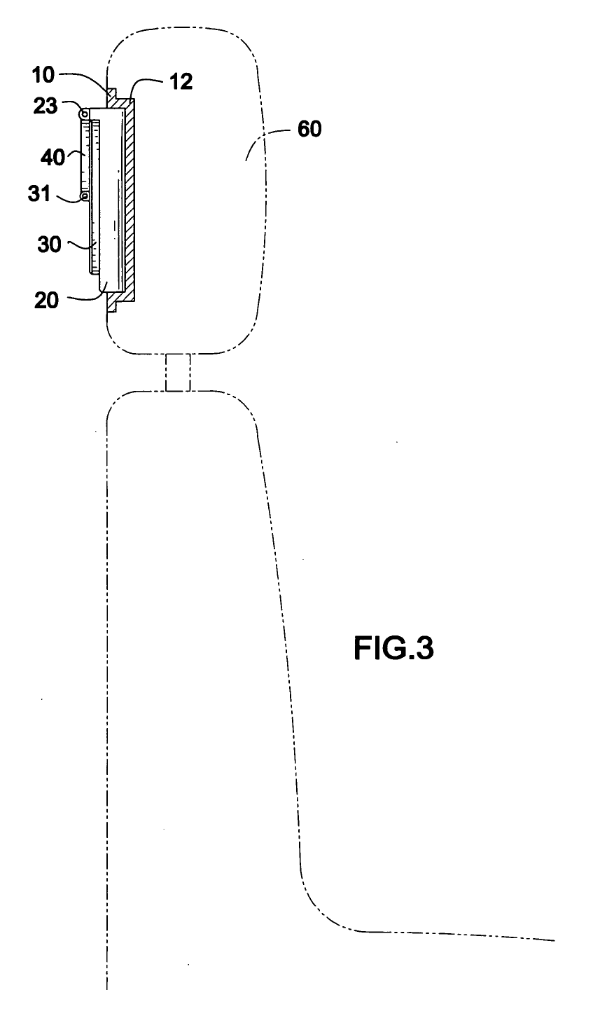

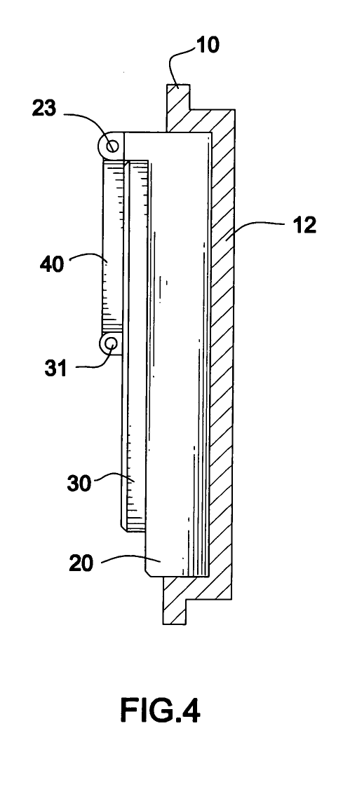

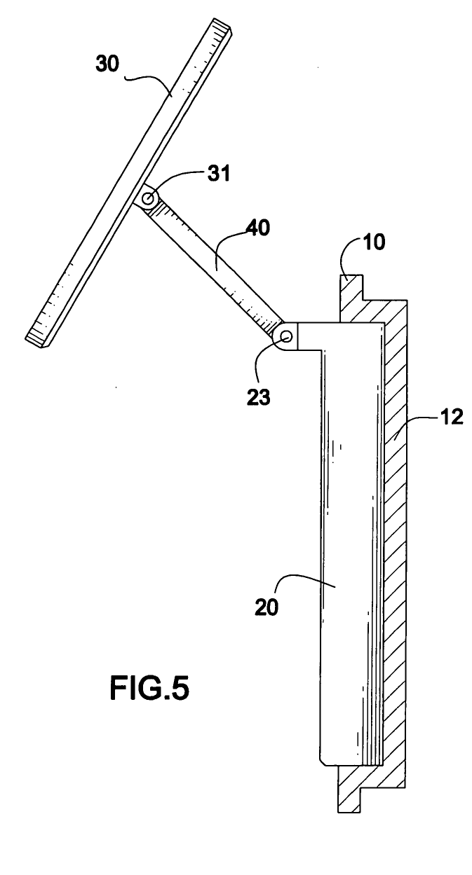

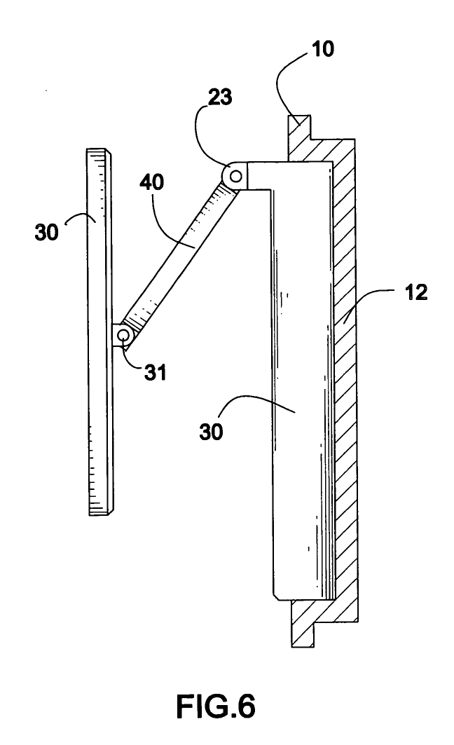

With reference to FIG. 3, when in use, the video/audio display device of the present invention is securely embedded in the headrest (60) of a front seat in the vehicle. Therefore, the passengers sitting at the backseat can directly use and watch the display device without the further assistance from the driver. To mount the display device into the headrest (60), the engagement base (10) is securely retained in a recess pre-defined in the headrest (60) whereby most parts of the display device are concealed in the recess. When a dust-proof cover is further applied on the display device, the headrest (60) will seem like an ordinary one and thus not attract the attention of thieves. With reference to FIG. 4, when the video/audio display device is not in use, the display panel (30) is folded to abut to the disc player (20) to save space. With such a folding status, since the inner side of the display panel for image display is not exposed, the display panel is protected from damage such as scratching. As shown in FIG. 5, the display panel (30) is raised through the action of the first pivoting mechanism (23) and fixed at a desired angle, so that the disc to be played can be put into the exposed disc retaining chamber (21). With reference to FIG. 6, the angle adjusting plate (40) is further pressed downward, and simultaneously the second pivoting mechanism (31) is also adjusted in such a way that the display panel (30) is substantially parallel to the disc player (20).

The aforementioned angle adjustments of the first and the second pivoting mechanisms (23)(31) are used as an example for explaining the action. Actually, users can based on their requirements orientate the display panel at a comfortable position for viewing.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An in-vehicle video/audio display device comprising:
an engagement base (10) defined with a shallow cavity (11), wherein the engagement base (10) is adapted to be embedded in a desired position in a vehicle;
a disc player (20) securely retained in the cavity (11) of the engagement base (10), wherein a first pivoting mechanism (23) is formed at a top edge of the disc player (20);
a display panel (30) having an inner surface for image display and an outside surface on which a second pivoting mechanism (31) is formed;
an angle adjusting plate (40) having two opposite edges along which a first pivoting block (41) and a second pivoting block (42) are formed, wherein the two pivoting blocks (41)(42) are respectively connected to the first pivoting mechanism (23) and the second pivoting mechanism (31), whereby the display panel (30) is pivotally linked to the disc player (20);
wherein after the first pivoting mechanism (23) and the second pivoting mechanism (31) are adjusted to a desired angle, the display panel (30) is maintained at the angle.

2. The video/audio display device as claimed in claim 1, wherein the engagement base (10) is formed as a rectangular body.

3. The video/audio display device as claimed in claim 2, wherein the disc player (20) has a disc retaining chamber (21) in which a disc to be played is placed, and a plurality of operation buttons (22) to be pressed by users is provided around the disc retaining chamber (21).

4. The video/audio display device as claimed in claim 3, wherein the display panel (30) is a flat type LCD display device.
